(19) United States
(12) Patent Application Publication
(10) Pub. No.: US 2006/0006611 A1
(43) Pub. Date: Jan. 12, 2006

(54) Device for sealing a leadthrough for conduits in a constructional element

(76) Inventor: Christian Foerg, Dillishausen (DE)

Correspondence Address: DAVID TOREN, ESQ.;ABELMAN FRAYNE & SCHWAB, 666 THIRD AVENUE, NEW YORK, NY, 10017-5621, US

(21) Appl. No.: 11/173,650

(22) Filed: Jun. 30, 2005

(30) Foreign Application Priority Data
Jul. 7, 2004 (DE) 10 2004 032 869.2

(51) Int. Cl. F16L 17/00

(52) U.S. Cl. 277/602

(57) ABSTRACT

A device for sealing a leadthrough for conduits in a constructional element includes an inherently stiff frame member, and at least one sealing element (12) fixedly secured in the receiving region (17) of the frame member (11) and having an elastic envelope (13), and a connection opening element (15) arranged on the envelope (13) and communicating with its receiving space (16) for effecting filling the receiving space (16) with medium for expanding the sealing element (12) and/or evacuating the receiving space (16) for contracting the sealing element (12).

### BACKGROUND OF THE INVENTION

1. Field of the Invention

The present invention relates to a device for sealing a leadthrough for conduits in a constructional component or element and including at least one sealing element having an elastic envelope having a receiving space, and connection opening means arranged on the envelope and communicating with the receiving space for effecting filling the receiving space with medium for expanding the sealing element and/or evacuating the receiving space for contracting the sealing element.

2. Background of the Invention

In order to subsequently pass conduits through constructional elements such as, e.g., walls or sealings, leadthroughs are provided therein. In order to prevent, in case of fire, spreading of the fire in a building through the leadthroughs, they should be sealed with suitable means. In addition to preventing the spread of fire, the spread of flue gases, which are produced in case of fire, also should be prevented.

German Publication DE 199 55 765 discloses a device for sealing a leadthrough for an object in a constructional element and including at least one band-shaped elastic sealing element that is arranged in a clearance between the leadthrough, which is provided in the constructional element, and the object, e.g., a conduit extending through the leadthrough. The sealing element consist, in its initial position, of an elastic core which is surrounded by a closed jacket that holds the sealing element in a compressed state. In its compressed state, the sealing element can be wound about the object and be inserted into the leadthrough together with the object. With a slitting-open device which is connected with the jacket, the jacket can be cut through or destroyed by being pulled over the slitting-open device. As a result, the core automatically aspirates air and expands. The expansion of the core completely closes the leadthrough.

The drawback of the known device consist in that it can be used only once. After the device has been mounted, the jacket is destroyed, and the sealing element can be removed from the leadthrough only if it is also destroyed. Furthermore, upon installation of a further object in the leadthrough, the destruction of the sealing element and the installation of a new sealing element is unavoidable.

German Publication DE 41 05 625 discloses a device for sealing a leadthrough in form for a sheath for a cable arranged in a cable channel or in a leadthrough of a constructional element. The sheath has an envelope the walls of which are formed of a foil-like material. The envelope is connected with a hose or a valve which provides for flow of fluid into the interior of the envelope. Upon the fluid filling the envelope, it expands closing the clearance between the cable and the cable channel.

The drawback of the device of DE 41 05 625 consists in that because of the moisture permeability of the envelope, a reservoir should be provided that is connected with the envelope by hose or valve through which the fluid, which escapes the envelope, is removed. Upon emptying of the envelope, it collapses, and the sheath can be removed from the cable channel.

An object of the present invention is a device for sealing a leadthrough for conduits in which the drawbacks of known sealing devices are eliminated.

Another object of the present invention is to provide a device for sealing a leadthrough for conduits and which can be closed and open multiple times.

### SUMMARY OF THE INVENTION

These and other objects of the present invention, which will become apparent hereinafter, are achieved by fixedly securing the sealing element in a receiving region of the inherently stiff frame member. The frame member which is formed, e.g., of a steel or a similar rigid material, supports the sealing element in both compressed and expanded conditions and insures that the sealing element does not fall out of the leadthrough in its compressed condition. The frame member also provides for a directional compression, i.e., that the sealing element opens and closes in a predetermined direction. As a result, repeated openings and closings of the device are easily implemented.

Advantageously, at least one porous and elastic element is arranged in the receiving space of the sealing element the cellular grid of which is self-resetting and self-inflating. After the sealing element has been compressed upon application of vacuum thereto, it automatically expands when air or other medium has an unhindered access to the element.

Advantageously, the receiving space of the sealing element is completely filled with the porous and elastic element, so that the sealing element can expand completely automatically upon entry of air.

Advantageously, the receiving region of the frame member is formed as a tubular section that provides for a flat attachment and guidance of the sealing element over the axial length of the leadthrough. The tubular section can be inserted in a leadthrough in a constructional component such as a wall or a ceiling, with the tubular section being advantageously sealed against the leadthrough. The tubular section can have an arbitrarily cross-section, e.g., round, elliptical, cuboid, polygonal, etc.

Advantageously, the at least one sealing element is secured in the receiving region of the frame member by a glue connection, which permits to easily achieve a flat connection of the sealing element with the frame member.

Advantageously, the frame member has an attachment section for securing the device on the constructional component. With the attachment section the device can be secured on a wall, ceiling, and the like. Advantageously, a sealing member is provided on the attachment section for sealingly abutting the constructional component, which enables a flue gas proof mounting of the frame member on the constructional element.

It is further advantageous when the sealing element is connected with a vacuum-producing device, e.g., vacuum pump or a vacuum cleaner. Thereby, in a simple manner, by a temporarily connection of the sealing element with the vacuum-producing device, compression of the sealing element and opening of the device for receiving the conduit can be achieved.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiment, when read with reference to the accompanying drawings.

### BRIEF DESCRIPTION OF THE DRAWINGS

The drawings show:

FIG. 1 a plan view of a device for sealing a conduit leadthrough and which is mounted in a constructional element and is shown in its initial position;

FIG. 2 a cross-sectional view along line II-II in FIG. 1;

FIG. 3 a cross-sectional view corresponding to that of FIG. 2 and showing the device in an open position with the conduit extending therethrough; and

FIG. 4 a cross-sectional view similar to that of FIG. 3 but showing the device in its sealing condition.

### DETAILED DESCRIPTION OF THE PREFERRED EMBODIMENTS

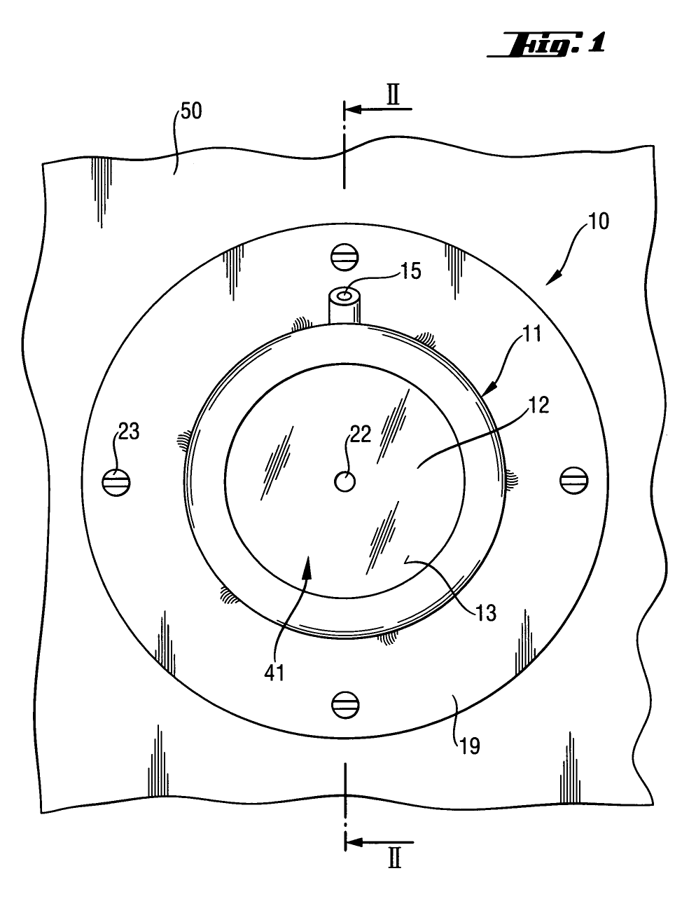

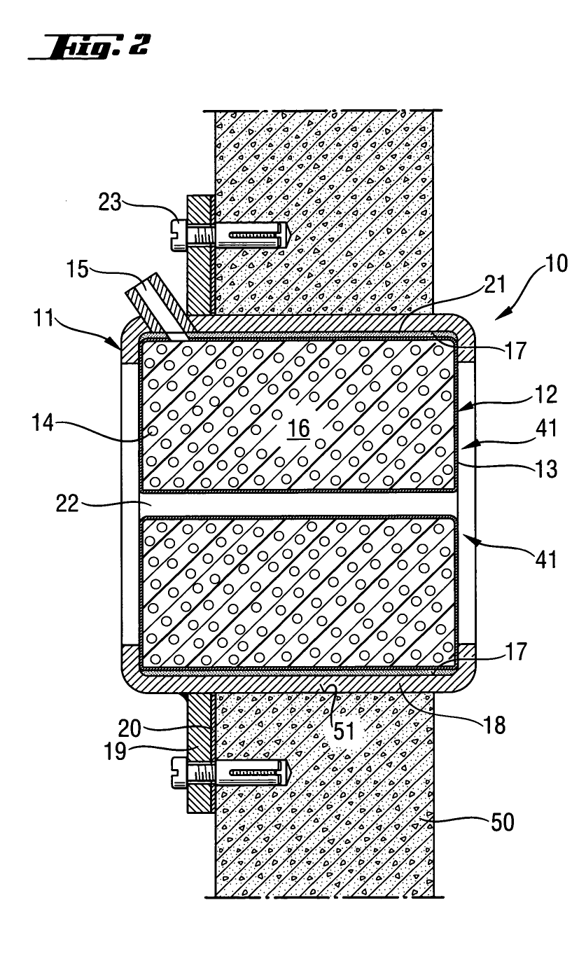

FIGS. 1-2 show a device 10 according to the present invention for sealing a leadthrough 51 for conduits 30 in a constructional element 50. The sealing device 10 is shown in its initial position 41. The device 10 includes an inherently stiff frame member 11 formed, e.g., of sheet steel or a similarly rigid material. The frame member 11 forms a tubular section 18 which has, in the embodiment shown in the drawings, a circular cross-section. In the tubular section 18, there is formed a receiving region 17 in which an annular sealing element 12 is secured with glue, forming a glue connection 21 with the tubular section 18. The sealing element 12 has an elastic envelope 13 that surrounds a receiving space 16 which is filled with a porous elastic element 14. As a material for the elastic envelope 13 all types of foils can be used. The foils can be made fireproof, e.g., be covered with a fire-resistant coating familiar to one skilled in the art. The porous elastic element 14 can consist, e.g., of fire-resistant foam or intumescent foam material. Alternatively, in the elastic envelope 13, a plurality of porous and elastic elements or masses of compressible material can be arranged, such as e.g., foam flakes, polystyrene balls, rubber granules, mineral or glass wool. The elastic envelope 13 is provided with a connection opening 15 formed as a tubular union. The sealing element 12 surrounds an opening 22 extending from one axial end of the sealing element 12 to another axial end of the sealing element 12.

On the frame member 11, there is provided an attachment section 19 that surrounds the tubular section 18. The attachment section 19 provides for securing the device 10 to the constructional element 50 with fastening means 23, e.g., with screws, anchors, dowels. In the attached condition of the device 10, the tubular section 18 is located in the leadthrough 51 the inner diameter of which substantially corresponds to the outer diameter of the tubular section 18. In order to achieve a good flue gas sealing of the frame member 11 against the constructional element 50 and the leadthrough 51, a sealing element 20 can be provided on a side of the attachment section 19 adjacent to the constructional component 50. The sealing element 20 can, e.g., consist of an intumescent material.

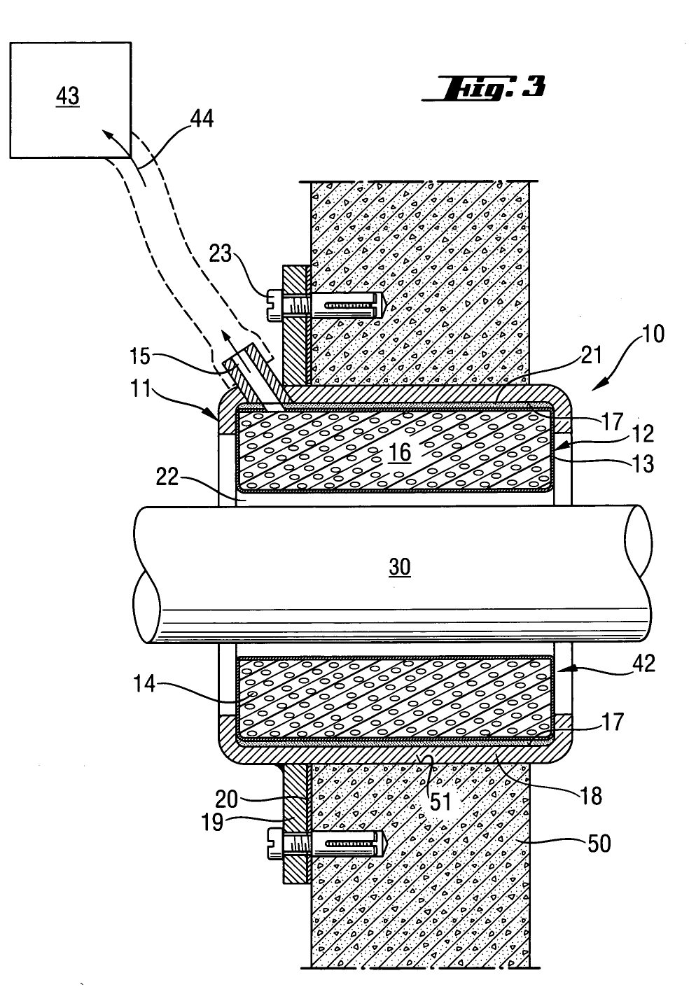

In order to pass one or several conduits 30, such as cables, pipes, or similar objects through the device 10, which is located in the leadthrough 51, the connection opening 15 is connected with a vacuum-producing device 43, e.g., a vacuum-pump, as shown in FIG. 3. With the vacuum-producing device 43, air or another fluid medium, which is located in the sealing element 12, is aspirated therefrom (in a direction shown with arrow 44). As a result, the sealing element 12 contracts, as shown in FIG. 3, whereby the diameter of the opening 22 increases. The compression of the sealing element 12 is facilitated by the fact that the sealing element is flatly connected with the tubular section 18 of the frame member 11 by the glue connection 21.

The evacuation of air or other medium from the sealing element 12 results in an opening condition 42 of the device 10, and the conduit 30 can be pushed thereinto or therethrough (as shown in FIG. 3).

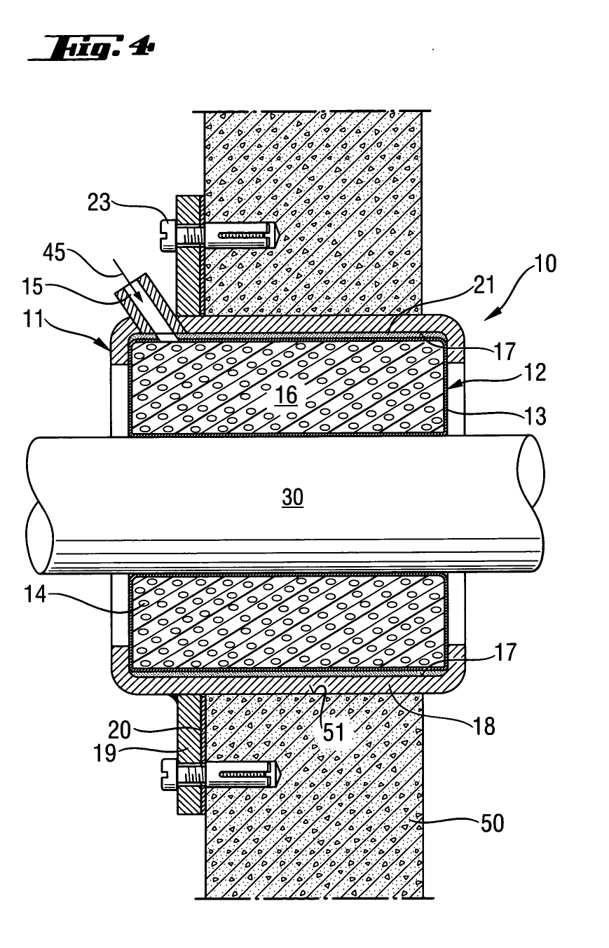

In order to seal the conduit 30, which was pushed through, the connection of the connection opening opening 15 with the vacuum-producing device or apparatus 13 should be broken, e.g., by disconnecting the connection opening 15 and/or by turning the vacuum-producing apparatus 43 off. By forming the elastic and porous element 14 of the sealing element 12 as a self-inflating element, it is achieved that the sealing element 12 automatically aspirates air through the connection opening 15 (in a direction shown with arrow 45 in FIG. 4) after the apparatus 43 has been disconnected, so that the sealing element 12 expands again, sealingly closing the opening 22 around the conduit.

Evacuation of the sealing element 12 for opening the device 10, e.g., in order to pass through further conduits 30 through the device 10, and a subsequent closing of the device 10 can be effected in a manner described above.

Though the present invention was shown and described with references to the preferred embodiment, such is merely illustrative of the present invention and is not to be construed as a limitation thereof and various modifications of the present invention will be apparent to those skilled in the art. It is therefore not intended that the present invention be limited to the disclosed embodiment or details thereof, and the present invention includes all variations and/or alternative embodiments within the spirit and scope of the present invention as defined by the appended claims.

What is claimed is:

1. A device for sealing a leadthrough for conduits in a constructional element, comprising an inherently stiff frame member (11) having a receiving region (17); and at least one sealing element (12) fixedly secured in the receiving region of the frame member (11) and having an elastic envelope (13) having a receiving space (16), and connection opening means (15) arranged on the envelope (13) and communicating with the receiving space (16) for effecting at least one of filling the receiving space (16) with medium for expanding the sealing element (12) and evacuating the receiving space (16) for contracting the sealing element (12).

2. A device according to claim 1, further comprising at least one porous and elastic element (14) arranged in the receiving space (16).

3. A device according to claim 2, wherein the at least one porous and elastic element (14) fills the receiving space (16).

4. A device according to claim 1, wherein the receiving region (17) of the frame member (4) is formed as a tubular section (18).

5. A device according to claim 1, wherein the sealing element (12) is secured in the receiving region (17) of the frame member (11) by a glue connection (21).

6. A device according to claim 1, wherein the frame member (11) has an attachment section (19) for attaching the device (10) to the constructional element (50).

7. A device according to claim 6, wherein the attachment section (19) has a sealing element (20) provided thereon for sealingly attaching the attachment section (19) to the constructional element (50).

8. A device according to claim 1, further comprising a vacuum-producing apparatus (43) connectable with the connection opening means (15).
